(19) United States
(12) Patent Application Publication
(10) Pub. No.: US 2020/0242967 A1
(43) Pub. Date: Jul. 30, 2020

(54) ADHESIVE NOTE SET FOR FOREIGN LANGUAGE LEARNING AND MANUFACTURING DEVICE THEREOF

(71) Applicants: Bang Ho LIM, Seoul (KR); Seung Jae LIM, Goyang-si (KR)

(72) Inventors: Bang Ho LIM, Seoul (KR); Seung Jae LIM, Goyang-si (KR)

(21) Appl. No.: 16/362,171

(22) Filed: Mar. 22, 2019

(30) Foreign Application Priority Data
Jan. 29, 2019 (KR) 10-2019-0011150

(51) Int. Cl. G09B 19/08; B42D 5/00

(52) U.S. Cl. CPC G09B 19/08; B42D 5/003

(57) ABSTRACT

An adhesive note set for foreign language learning, capable of learning various foreign language sentences while users are interested in learning, by printing types of a subject part and a predicate part of a foreign language to learn in a state of being divided by color in adhesive note inlays in advance, and, at the same time, manufacturing a subject, a predicate, an object, a complement, and a modifier as forms of post-its so as to correspond to the grammar type of the corresponding language, and then providing the forms of post-its as a separate packaging, and a manufacturing device thereof are disclosed.

### CROSS-REFERENCE TO RELATED APPLICATIONS

This application claims the benefit of priority of Korean Application No. 10-2019-0011150, filed Jan. 29, 2019, in the Korean Intellectual Property Office. All disclosures of the document named above are incorporated herein by reference.

### BACKGROUND

The present invention relates to an adhesive note set for foreign language learning and a manufacturing device thereof, and more particularly, to an adhesive note set for foreign language learning which is capable of easily and conveniently learning various foreign language sentences while the user does not lose interest when learning a foreign language himself/herself, by printing types of a subject part and a predicate part of the corresponding language in a state of being divided by color in adhesive note inlays in advance, at the same time, manufacturing a subject, a predicate, an object, a complement, and a modifier corresponding to the corresponding types as forms of post-its, and then providing the forms of post-its as a separate packaging, for children, students, or adults who intend to learn a foreign language easily, and a manufacturing device thereof.

In general, notes are often used as a use to summarize and organize highlighted contents to be important by a teacher or a lecturer during class time or lecture time, the less understandable part during class or lecture, or the like.

A well-organized note has a great effect of reviewing just by unfolding the note and reading the note once. Therefore, students are worried about how to organize their notes effectively.

An example of a note-organizing method for improving students' learning effects is the Cornelian note-organizing method developed by Water Pauk, professor of education at Cornell University in the United States in the 1950s. The note-organizing method is introduced to many college students around the world as a note writing method which divides a note region into four regions such as a title region, a handwriting region, a clue region, and a summary region and consists of five learning methods of recording, shortening, memorizing, reflecting, and reviewing.

As another example, there is a Da Vinci note-organizing method, which relates to six basic note-organizing principles which divide a note region into a title region, a key summary region, an information input region, and a self-thought and a question (supplementary explanation) region.

By the way, the note-organizing methods described above are mainly for educating the students who complete the formal education course, so the note-organizing method described above does not adequately meet the needs of special purpose learners, for example, those who want to learn a foreign language such as English, Chinese, and Japanese easily and funny.

Accordingly, various studies have been attempted in the related industry to develop and disseminate a note which is specialized in foreign language learning.

For example, in Korean registered utility model No. 20-0426880 (Registered Date: Sep. 12, 2006), books and notebooks capable of displaying learning outcomes are disclosed. According to this registered utility model, since at least one cover marker which is capable of displaying the repeated learning outcomes in a word page and/or a meaning page is printed and provided in a word book, a workbook, an examination book, a Chinese character learning book, a notebook, or the like, it is possible to manage the outcomes of the repeated learning by displaying whether the learning contents are memorized or understood.

However, since these books and notebooks are proposed mainly focusing on the outcomes of repeated learning, the learning purpose that children, students, or adults learn foreign languages fun and easy is not met.

As another example, Korean registered utility model No. 20-0439592 (Registered Date: Apr. 14, 2008) discloses a note inlay for foreign language learning. According to this registered utility model, each line of the note inlay is configured by being divided into a learning content writing portion and a supplementary content writing portion so as to make it more convenient to fill pinyin (=pronunciation key of Chinese) or hiragana of Japanese, correction of writing, and supplementary explanation writing in learning foreign languages such as English, Chinese, and Japanese.

However, although the note inlay for foreign language learning can help intensive learning of foreign language reading and vocabulary, it is not enough to induce interest in overall learning of foreign languages, and it is difficult to help in learning foreign language grammar easily.

Korean registered patent No. 10-1175854 (Registered Date: Aug. 14, 2012) discloses a note for foreign language learning. According to this registered patent, so as to allows students to make and learn various foreign language sentences by naturally applying the basic sentences learned in the foreign language class time, a description field printed on a front surface of the note inlay is divided into a description field of class contents and a description field of the Hangul sentences, and a description field printed on a back surface of the note inlay is composed of the description field of foreign language sentences and is further divided into a parent check field and a teacher check field.

However, although the note for foreign language learning helps the level of foreign language learning of students evaluate by parents or teachers, the note is insufficient to cause an interest that allows students to voluntarily learn a foreign language and is difficult to give much help to learn foreign language grammar easily.

### SUMMARY

Technical challenge to be solved by the present invention is to provide an adhesive note set for foreign language learning which is capable of easily and conveniently learning various foreign language sentences while the user does not lose interest when learning a foreign language himself/herself, by printing types of a subject part and a predicate part of a foreign language to learn in a state of being divided by color in adhesive note inlays in advance, at the same time, manufacturing a subject, a predicate, an object, a complement, and a modifier corresponding to the corresponding type as forms of post-its, and then providing the forms of post-its as a separate packaging, and a manufacturing device thereof.

So as to solve the technical challenge described above, according to a first aspect of the present invention, the present invention provides an adhesive note set for foreign language learning including:

an adhesive note which includes a note cover composed of a front cover and a back cover, and a plurality of inlays, one edge of which is integrally joined to an inside surface of the note cover by adhesives or binding means, wherein a release agent is coated on a first surface of the inlay with a thickness of 10-12 μm, hot-melt adhesives are coated on a second surface of the inlay with a thickness of 10-12 μm, and types of a subject part and a predicate part of the foreign language are printed on the second surface in a state of being divided by color in advance; and

post-its which can be detachably attached to the second surface, and in which words representing the subject part and the predicate part, respectively, are printed on the surface in a state of being divided by color in advance, corresponding to the types of the subject part and the predicate part of the foreign language printed on the second surface.

The release agent is composed of a silicon mixture solution and is prepared by not more than 30 parts by weight of aminopropylaminoethylpolysiloxane and not more than 65 parts by weight of water, with respect to 100 parts by weight of the silicone mixture solution.

The hot-melt adhesives are composed of an acrylic adhesive coating solution and are prepared by 48 to 52 parts by weight of water, 48 to 52 parts by weight of acrylic polymer, and 0.5 to 1.5 parts by weight of a surfactant, with respect to 100 parts by weight of the acrylic adhesive coating solution.

In a case where the types of the subject part and the predicate part of the corresponding foreign language printed on the second surface are first types, two language type input fields each representing a subject and a verb are printed in color in advance, in a case of being second types, three language type input fields each representing a subject, a (intransitive) verb, and a complement are printed in color in advance, in a case of being third types, three language type input fields each representing a subject, a (transitive) verb, and an object are printed in color in advance, in a case of being fourth types, four language type input fields each representing a subject, a (transitive) verb, an indirect object, and a direct object are printed in color in advance, and in a case of being of fifth types, four language type input fields each representing a subject, a (transitive) verb, an object, and an objective complement are printed in color in advance.

In a case where the types of the subject part and the predicate part of the corresponding foreign language are the first types, a first input field of the two language type input fields is printed in red corresponding to a subject and a second input field is printed in orange corresponding to a verb, and correspondingly, the post-its having a size, a shape, and a color matching with the language type input fields are provided, and words corresponding to a subject and a verb, respectively, are printed in advance in the language type input fields provided on the surfaces of the post-its and are provided.

In a case where the types of the subject part and the predicate part of the corresponding foreign language are the second types, a first input field of the three language type input fields is printed in red corresponding to a subject, a second input field is printed in orange corresponding to a (intransitive) verb, and a third input field is printed in green corresponding to a complement, and accordingly, the post-its having a size, a shape, and a color matching with the language type input fields are provided, and words corresponding to a subject, and a (intransitive) verb, and a complement, respectively, are printed in advance in the language type input fields provided on the surfaces of the post-its and are provided.

In a case where the types of the subject part and the predicate part of the corresponding foreign language are the third types, a first input field of the three language type input fields is printed in red corresponding to a subject, a second input field is printed in yellow corresponding to a (transitive) verb, and a third input field is printed in blue corresponding to an object, and accordingly, the post-its having a size, a shape, and a color matching with the language type input fields are provided, and words corresponding to a subject, and a (transitive) verb, and an object, respectively, are printed in advance in the language type input fields provided on the surface of the post-its and are provided.

In a case where the types of the subject part and the predicate part of the corresponding foreign language are the fourth types, a first input field of the four language type input fields is printed in red corresponding to a subject, a second input field is printed in yellow corresponding to a (transitive) verb, a third input field is printed in violet corresponding to an indirect object, and a fourth input field is printed in pink corresponding to a direct object, and accordingly, the post-its having a size, a shape, and a color matching with the language type input fields are provided, and words corresponding to a subject and a (transitive) verb, an indirect object, and a direct object, respectively, are printed in advance in the language type input fields provided on the surface of the post-its and are provided.

In a case where the types of the subject part and the predicate part of the corresponding foreign language are the fifth types, a first input field of the four language type input fields is printed in red corresponding to a subject, a second input field is printed in yellow corresponding to a (transitive) verb, a third input field is printed in blue corresponding to an object, and a fourth input field is printed in sky-blue corresponding to an objective complement, and accordingly, the post-its having a size, a shape, and a color matching with the language type input fields are provided, and words corresponding to a subject, and a (transitive) verb, an object, and an objective complement, respectively, are printed in advance in language type input fields provided on the surface of the post-its and are provided.

In addition, according to a second aspect of the present invention, there is provided a manufacturing device of an adhesive note set for foreign language learning, including:

an automatic paper feeder and a paper loading conveyor for supplying a large amount of initial paper;

a transfer roll and an impressing roll which are vertically disposed on an outlet side of the paper loading conveyor 410 in a state of forming a pair, rotate in directions opposite to each other, and are spaced apart from each other so as to allow the initial paper to pass therethrough;

a coating roll which is disposed on one side of the transfer roll in the radial direction, has a heater disposed therein, and rotates in a direction opposite to a rotating direction of the transfer roll;

a transfer conveyor which is disposed downstream of the coating roll at the outlet sides of the transfer roll and the impressing roll;

a release agent supplying tank which is disposed at an adjacent position of one side of the coating roll in the radial direction and holds and supplies a release agent to be applied to one surface of the initial paper with a predetermined thickness; and

a hot-melt adhesive melt tank which is disposed in parallel with the release agent supplying tank at an adjacent position of one side of the coating roll in the radial direction and holds and supplies hot-melt adhesives to be applied on the other surface of the paper coated with the release agent with a predetermined thickness, in which a heating line is built in and disposed on a side wall and a bottom of the hot-melt adhesive melt tank.

As described above, the present invention causes those who want to learn a foreign language to be capable of easily and conveniently learning foreign language sentences with interest, by printing the types of a subject part and a predicate part of a foreign language in the form of figures or sketches in a state of being divided by color on adhesive note inlays in advance, at the same time, manufacturing a subject, a predicate, an object, a complement, and a modifier corresponding to the corresponding types as forms of post-its, and then providing the forms of post-its as a separate packaging.

Especially, people of low ages such as children, people of high ages such as elderly people with inferior physical abilities and low learning abilities, and ordinary people who have difficulty in learning foreign languages can easily learn foreign languages.

In addition, since the note inlay to which the release agent is applied can freely memorize contents which are deemed necessary at the time of learning a foreign language or attach figures and thus it is possible to repeat the contents learned at the time of foreign language learning, it is possible to further revitalize the connection in the brain.

### BRIEF DESCRIPTION OF THE DRAWINGS

FIG. 1 is a schematic view illustrating a manufacturing device of an adhesive note set for foreign language learning according to a preferred embodiment of the present invention, in which a release agent coating and a hot-melt adhesive coating are illustrated in stepwise,

FIG. 2 is a perspective view illustrating an adhesive note set for foreign language learning according to a preferred embodiment of the present invention,

FIG. 3, FIG. 4A, FIG. 4B and FIG. 4C are diagrams illustrating a using method for learning the first type sentence to the fifth type sentence in English, as an example of language learning using the adhesive note set for foreign language learning illustrated in FIG. 2, and

FIG. 5, FIG. 6A, FIG. 6B and FIG. 6C are diagrams illustrating a using method for learning the first type sentence to the fifth type sentence in Chinese, as an example of language learning using the adhesive note set for foreign language learning illustrated in FIG. 2.

### DETAILED DESCRIPTION OF THE EMBODIMENTS

Hereinafter, an adhesive note set for foreign language learning and a manufacturing device thereof according to preferred embodiments of the present invention will be described in detail with reference to the accompanying drawings.

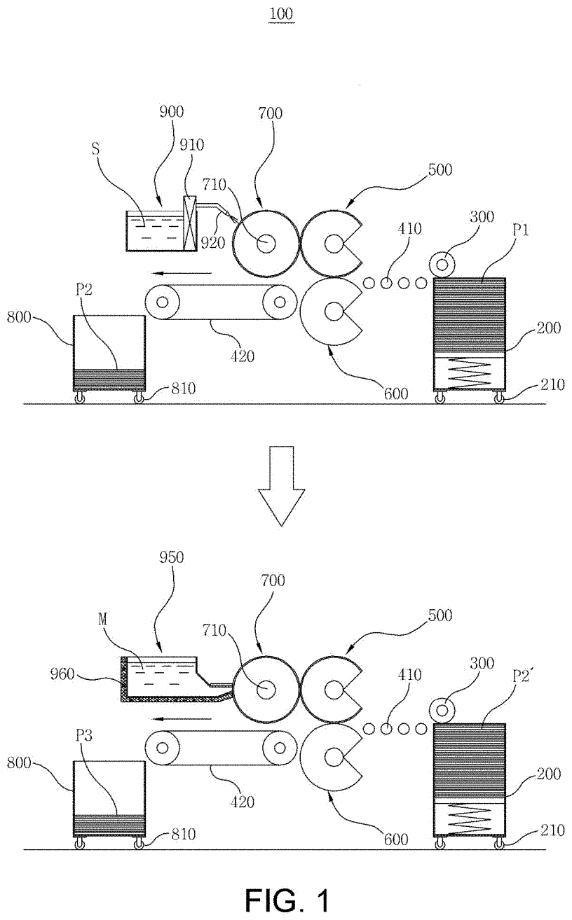

FIG. 1 schematically illustrates a structure of a manufacturing device 100 of an adhesive note set for foreign language learning according to a preferred embodiment of the present invention.

Referring to FIG. 1, the manufacturing device 100 of an adhesive note set for foreign language learning includes a paper loading box 200 for supplying a large amount of initial paper P1. The large amount of initial paper P1 is loaded inside the paper loading box 200 in advance and the paper loading box 200 can be conveniently moved using wheels 210 attached to a lower outer bottom of the paper loading box 200. An automatic paper feeder 300 for automatically feeding initial paper P1 is disposed above the paper loading box 200.

An inlet side of a paper loading conveyor 410 is disposed at a position adjacent to the automatic document feeder 300, and the paper loading conveyor 410 horizontally extends and is disposed in a direction away from the paper loading box 200. Since the automatic paper feeder 300 and the paper loading conveyor 410 are typically used in a printing device or the like, a detailed description with respect to the configurations and actions thereof will be omitted.

The manufacturing device 100 includes a transfer roll 500 and an impressing roll 600 which are disposed vertically on an outlet side of the paper loading conveyor 410 in a state of forming a pair. As illustrated by the arrow in FIG. 1, when the feeding direction from the right side to the left side is taken as a reference, the transfer roll 500 is rotated in the clockwise direction, the impressing roll 600 is rotated in the counter-clockwise direction, and the initial paper P1 discharged from the outlet side of the paper loading conveyor 410 passes through a gap formed between the transfer roll 500 and the impressing roll 600.

A coating roll 700 is disposed on one side of the transfer roll 500 in a radial direction, and a heater 710 is disposed inside the coating roll 700. When the feeding direction is taken as a reference, the coating roll 700 is disposed downstream of the transfer roll 500 and rotates in a direction opposite to the rotation direction of the transfer roll 500, that is, in the counter-clockwise direction.

An entrance side of a transfer conveyor 420 is disposed below the coating roll 700 at the outlet side of the transfer roll 500 and the impressing roll 600. The transfer conveyor 420 horizontally extends and is disposed along a paper feeding direction as indicated by an arrow in FIG. 1. A storage box 800 is disposed on an outlet side of the transfer conveyor 420. In the storage box 800, an adhesive note paper P2 coated with adhesives on the surface thereof is successively stored by the impressing roll 600. A wheel 810 is attached to the lower outer bottom of the storage box 800 to allow the storage box 800 to be conveniently moved.

Meanwhile, a release agent supplying tank 900 for holding and supplying a release agent to be applied to one surface of the initial paper P1 with a predetermined thickness is disposed at an adjacent position of one side of the coating roll 700 in the radial direction. A pump 910 and a jet nozzle 920 are installed at one side of the release agent supplying tank 900. The release agent S used in the present invention is composed of a silicon mixture solution S. Preferably, the silicone mixture solution S is prepared of not more than 30 parts by weight of aminopropylaminoethylpolysiloxane and not more than 65 parts by weight of water, with respect to 100 parts by weight of the silicone mixture solution. The aminopropylaminoethylpolysiloxane has physical properties which are translucent liquid, are odorless, and have a boiling point of 100° C. or more (under a pressure of 1013 hPa).

The jet nozzle 920 is disposed so that the outlet side thereof is close to the outer surface of the coating roll 700 in the radial direction, which rotates in the counter-clockwise direction. The silicon mixture solution S is pumped by the pump 910 from the release agent supplying tank 900 and provided on the outer surface of the coating roll 700 in the radial direction via the jet nozzle 920.

A hot-melt adhesive melt tank 950 for holding and supplying hot-melt adhesives to be applied to the other surface of the paper P2 coated with the release agent with a predetermined thickness is also disposed at an adjacent position of one side of the coating roll 700 in the radial direction. The hot-melt adhesive melt tank 950 is disposed in parallel with the above-described release agent supplying tank 900. A heating line 960 for heating and melting the hot-melt adhesives M is built in and disposed on a side wall and a bottom of the hot-melt adhesive melt tank 950.

The hot-melt adhesives M used in the present invention use an acrylic adhesive coating solution and are prepared by 48 to 52 parts by weight of water, 48 to 52 parts by weight of acrylic polymer, 0.5 to 1.5 parts by weight of a surfactant, with respect to 100 parts by weight of the acrylic adhesive coating solution. The hot-melt adhesives M are heated to a temperature of 140° C. to 180° C. by the heating line 960 in a state of being charged in the hot-melt adhesive melt tank 950 to be melted. The coating roll 700 rotating in the counter-clockwise direction is disposed close to the hot-melt adhesives melt tank 950 so that the outer surface thereof in the radial direction can be in contact with the hot-melt adhesives M which is held in a state of being accommodated in the hot-melt adhesive melt tank 950 and being melted.

Hereinafter, the operation procedure of the manufacturing device 100 of an adhesive note set for foreign language learning configured as described above will be briefly described.

First, a large amount of initial paper P1 for coating the release agent on one surface thereof prior to the coating of the adhesives is loaded in the paper loading box 200, and then the paper loading box 200 is moved to the inlet side of the manufacturing device 100 to perform the preparation for manufacturing the adhesive note set.

When the manufacturing device 100 starts to operate, the initial paper P1 loaded in the paper loading box 200 is sequentially supplied to the side of the transfer roll 500 and the impressing roll 600 of the manufacturing device 100 from the uppermost paper by the automatic paper feeder 300 and the paper feeding conveyor 410.

Separately, a release agent composed of the silicon mixture solution S accommodated in the release agent supplying tank 900 is provided to the radial surface of the coating roll 700 via the jet nozzle 920 by the operation of the pump 910 and then successively transferred to the radial surface of the transfer roll 500.

The initial paper P1 supplied one by one by the automatic paper feeder 300 and the paper loading conveyor 410 passes between the transfer roll 500 and the impressing roll 600, and at this time, the release agent S is coated on one surface thereof with a thickness of 1 to 50 μm while being pressed by the impressing roll 600. Preferably, the release agent S is coated on one surface thereof with a thickness of 10 to 12 μm.

While passing between the transfer roll 500 and the impressing roll 600, the paper P2 coated with the release agent S is conveyed by the transfer conveyor 420, is sequentially stacked in the storage box 800 disposed below the outlet side of the transfer conveyor 420.

After the release agent S is coated on one surface of the paper P2, the paper P2 is inverted and is loaded in the paper loading box 200 so as to coat the other surface of the paper P2 with the hot-melt adhesives M, and then the paper loading box 200 is moved to the entrance side of the manufacturing device 100 to prepare for performing the preparation for manufacturing the adhesive note set.

When the manufacturing device 100 starts to operate, the inverted paper P2′ loaded in the paper loading box 200 is sequentially supplied to the side of the transfer roll 500 and the impressing roll 600 of the manufacturing device 100 from the uppermost paper by the automatic paper feeder 300 and the paper feeding conveyor 410.

Separately, the hot-melt adhesives M melted by the heating line 960 in a state of being accommodated in the hot-melt adhesive melt tank 950 pass through the radial surface of the coating roll 700 and then transferred to the radial surface of the transfer roll 500.

The inverted paper P2′ supplied one by one by the automatic paper feeder 300 and the paper loading conveyor 410 passes between the transfer roll 500 and the impressing roll 600, and at this time, the hot-melt adhesives M are coated on the surface thereof with a thickness of 1 to 50 μm while being pressed by the impressing roll 600. Preferably, the hot-melt adhesives M are coated with a thickness of 10 to 12 μm.

An adhesive note inlay P3 coated with hot-melt adhesives M on the surface thereof while passing between the transfer roll 500 and the impressing roll 600 is conveyed by the transfer conveyor 420 to sequentially load in the storage box 800 disposed on the lower side of the outlet side of the transfer conveyor 420.

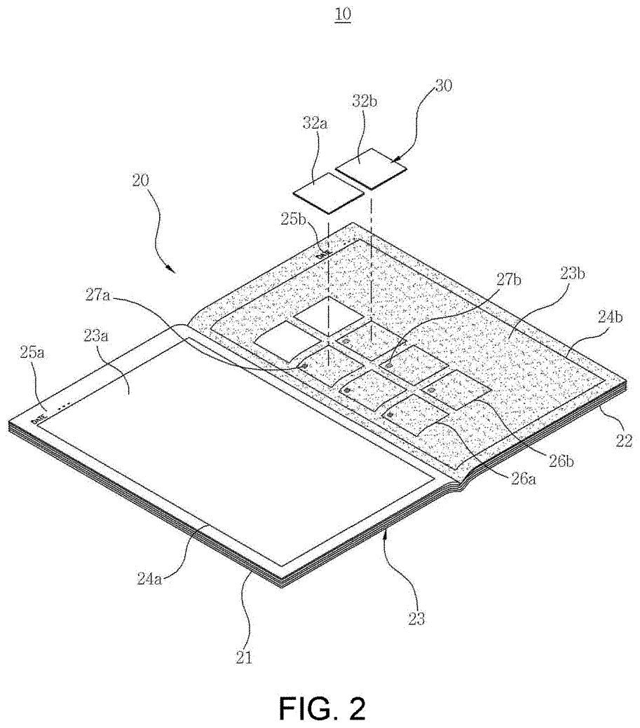

In attached FIG. 2, the adhesive note set 10 for foreign language learning according to a preferred embodiment of the present invention is illustrated.

Referring to FIG. 2, the adhesive note set 10 for the foreign language learning mainly includes an adhesive note 20 and post-its 30 which can be detachably attached to the inlay of the note 20.

The adhesive note 20 includes a note cover (omits reference numeral) which is composed of a front cover 21 and a back cover 22, and a plurality of inlays 23 in which one edge thereof is integrally attached to the inner surface of the note cover by adhesives or integrally joined using a binding string or a spring binding. It is easy to see that the inlay 23 corresponds to the finished adhesive note paper P3 by the release agent S being coated on one surface thereof with a thickness of 1 to 50 μm or a thickness of 10 to 12 μm by the manufacturing device 100 described above, and hot-melt adhesives M being coated on the other surface thereof with a thickness of 1 to 50 μm or a thickness of 10 to 12 μm.

The inlay 23 of the adhesive note 20 has a first surface 23a which is coated with a release agent S on the surface thereof and made of white paper so as to be capable of writing letters or drawing pictures and a second surface 23b coated with hot-melt adhesives M and printed by dividing the types of the subject part and the predicate part of the corresponding language for foreign language learning in color in advance. In other words, the surface coated with the release agent S corresponds to the first surface 23a of the inlay 23 and the surface coated with the hot-melt adhesives M corresponds to the second surface 23b of the inlay 23. In a case where the adhesive note 20 is folded, the first surface 23a can easily be separated from the second surface 23b to which the adhesives are applied, by the action of the release agent S.

The first surface 23a may be printed with an outline 24a along the edge thereof so that the user may freely memorize contents or attach figures which are thought to be needed by the user in a foreign language learning and a first notation portion 25a provided with an input field corresponding to a date, a page, or the like may be provided outside the outline 24a at the upper portion or the lower portion of the first surface 23a so that the date, the page, or the like can be filled therein.

Meanwhile, the adhesives described above are applied to the second surface 23b, which is the opposite surface of the first surface 23a, in whole or in part. An outline 24b can be printed on the second surface 23b along the edge thereof and on the outside of the outline 24b in the upper portion or in the lower portion of the second surface 23b, a second notation portion 25b provided with a corresponding input field may be provided so that the date, the page, or the like can be filled therein.

In the inner position of the outline 24b on the second surface 23b, the types of the subject part and the predicate part of the corresponding language are printed by being divided by color in advance for foreign language learning. For example, when the first type of English is learned, the language type input fields 26a and 26b representing a subject and a verb, respectively, are printed in color in advance. Preferably, the first input field 26a corresponds to a subject, and the second input field 26b corresponds to a verb. The first input field 26a is printed in red and the second input field 26b is printed in orange so that the user can easily divide between the first input field 26a and the second input field 26b. At this time, the entire input fields of the first input field 26a and the second input field 26b may be printed in the corresponding color, or a portion of the corresponding field of the color display portions 27a and 27b representing the corresponding color may be printed as a form of a mark.

A person skilled in the art will appreciate that the shapes and the colors of the language type input fields 26a and 26b or the shapes and the colors of the color display portions 27a and 27b can be changed as desired.

Corresponding to the language type input fields 26a and 26b printed by the types of the subject part and the predicate part of the foreign language being divided by color in advance on the second surface 23b, the English words which represent a subject and a verb, respectively are printed on the surface of the post-its 30 by being divided by color in advance. For example, when it is assumed that the first type of English is learned, language type input fields 32a and 32b respectively representing a subject and a verb are printed in color in advance. The user learns the corresponding language while attaching the post-its 30 in which the language type input fields 32a and 32b are printed in color corresponding to the color printed in the language type input fields 26a and 26b of the second surface 23b to the language type input fields 26a and 26b of the second surface 23b. At this time, the language type input fields 32a and 32b of the post-its 30 may print the entire input fields with corresponding colors or may print a color display portion representing the corresponding colors in a form of a mark on a portion of the corresponding fields. Preferably, the post-its 30 have a size and a shape matching with the language type input fields 26a and 26b of the second surface 23b.

Hereinafter, a process of learning a foreign language using the adhesive note set 10 configured as described above will be briefly described.

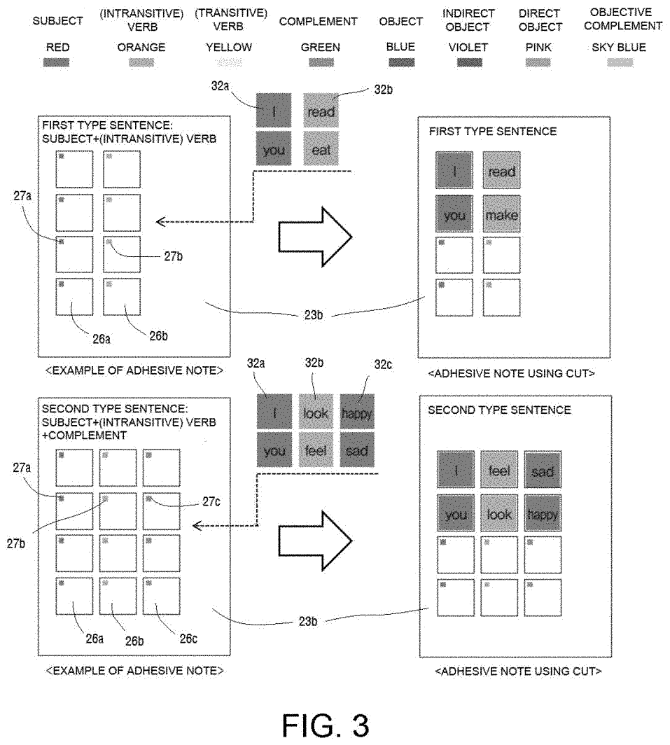

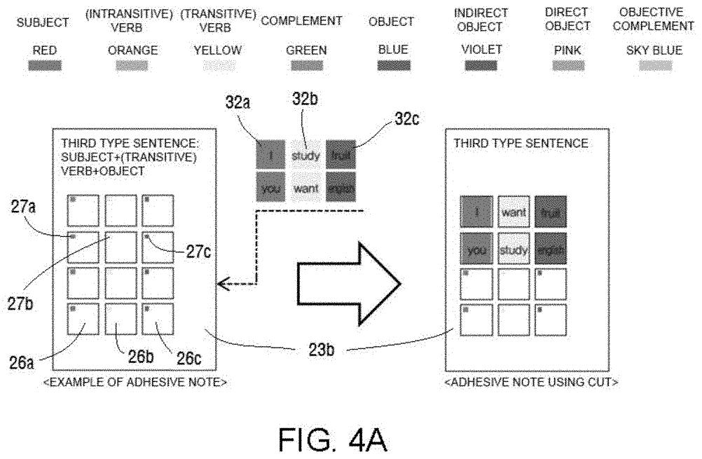

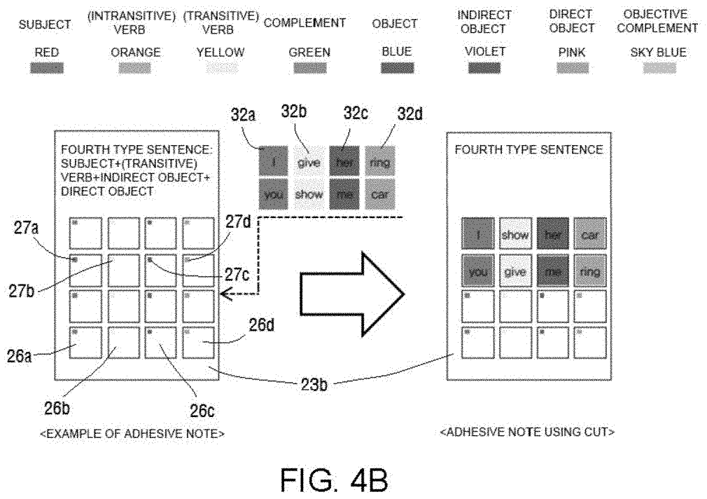

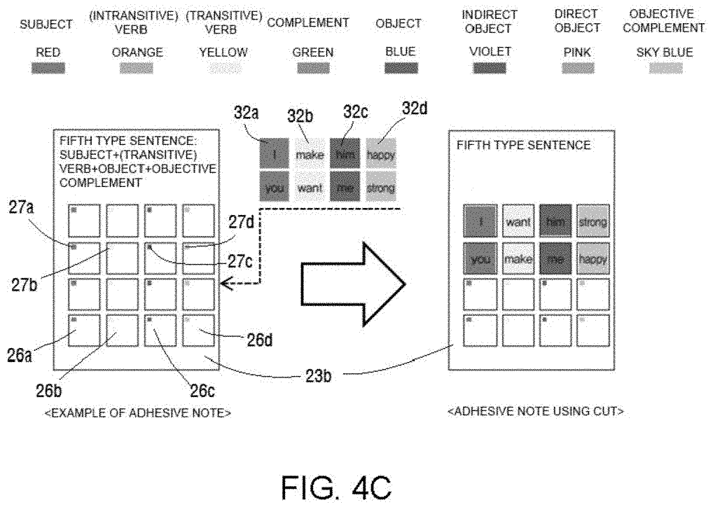

FIGS. 3 and 4A-4C illustrate an example of learning the first type sentence to the fifth type sentence of English using the adhesive note set 10.

Referring to FIGS. 3 and 4A-4C, in the second surface 23b and the post-its 30 of the adhesive note set 10, the color representing a subject in English is designated as red, and the color representing a (intransitive) verb in English is designated as orange, the color representing a (transitive) verb in English is designated as yellow. The color representing a complement in English is designated as green, the color representing an object in English is designated as blue, the color representing an indirect object in English is designated as violet, the color representing a direct object is designated as pink, and the color representing an objective complement is designated as sky-blue.

As illustrated in an upper side of FIG. 3, so as to be capable of easily learning the first type sentence of English by the user, two language type input fields 26a and 26b are printed on the second surface 23b of the adhesive note 20 and color display portions 27a and 27b are printed on one corner of the language type input fields 26a and 26b, respectively. At this time, the first color display portion 27a is colored red which represents a subject, and the second color display portion 27b is colored orange which represents a predicate, that is, a (intransitive) verb.

Correspondingly, post-its 30 having the size, the shape, and the color matching with the language type input fields 26a and 26b of the second surface 23b are provided. The language type input fields 32a and 32b provided on the surface of the post-its 30 are provided by printing a subject and a predicate in advance, respectively. The post-its 30 may be used by purchasing a commercially available post-its 30 by color and then printing English words or, on the other hands, by using the manufacturing device 100 of an adhesive note set according to the preferred embodiment of the present invention as described above, applying adhesives to one surface of a colored paper sheet, and printing English words on the back surface thereof.

Likewise, as illustrated in a lower side of FIG. 3, three language type input fields 26a, 26b, and 26c are printed on the second surface 23b of the adhesive note 20 so as to be capable of easily learning the second type sentences of English by the user, and color display portions 27a, 27b, and 27c are printed on one corner of the language type input fields 26a, 26b, and 26c, respectively. At this time, the first color display portion 27a is colored with red which represents a subject, the second color display portion 27b is colored with orange which represents a predicate, that is, a (intransitive) verb, and the third color display portion 27c is colored with green which represents a complement.

Correspondingly, post-its 30 having the size, the shape, and the color matching with the language type input fields 26a, 26b, and 26c of the second surface 23b are provided. The language type input fields 32a, 32b, and 32c provided on the surface of the post-its 30 are provided by printing a subject, a predicate, and a complement in advance, respectively.

Likewise, as illustrated in FIG. 4A, so as to be capable of easily learning the third type sentence of English by the user, three language type input fields 26a, 26b, and 26c are printed on the second surface 23b of the adhesive note 20 and color display portions 27a, 27b, and 27c are printed on one corner of the language type input fields 26a, 26b, and 26c, respectively. At this time, the first color display portion 27a is colored red which represents a subject, the second color display portion 27b is colored yellow which represents a predicate, that is, a (transitive) verb, and the third color display portion 27c is colored blue which represents an object.

Correspondingly, post-its 30 having the size, the shape, and the color matching with the language type input fields 26a, 26b, and 26c of the second surface 23b are provided. The language type input fields 32a, 32b, and 32c provided on the surface of the post-its 30 are provided by printing a subject, a predicate, and an object in advance, respectively.

As illustrated in FIG. 4B, so as to be capable of easily learning the fourth type sentence of English by the user, four language type input fields 26a, 26b, 26c, and 26d are printed on the second surface 23b of the adhesive note 20 and color display portions 27a, 27b, 27c and 27d are printed on one corner of the language type input fields 26a, 26b, 26c, and 26d, respectively. At this time, the first color display portion 27a is colored red which represents a subject, the second color display portion 27b is colored yellow which represents a predicate, that is, the (transitive) verb, the third color display portion 27c is colored violet which represents an indirect object, and the fourth color display portion 27d is colored pink which represents a direct object.

Correspondingly, post-its 30 having the size, the shape, and the color matching with the language type input fields 26a, 26b, 26c, and 26d of the second surface 23b are provided. The language type input fields 32a, 32b, 32c, and 32d provided on the surface of the post-its 30 are provided by printing a subject, a predicate, an indirect object, and a direct object in advance, respectively.

As illustrated in FIG. 4C, so as to be capable of easily learning the fifth type sentence of English by the user, four language type input fields 26a, 26b, 26c, and 26d are printed on the second surface 23b of the adhesive note 20 and color display portions 27a, 27b, 27c, and 27d are printed on one corner of the language type input fields 26a, 26b, 26c, and 26d, respectively. At this time, the first color display portion 27a is colored red which represents a subject, the second color display portion 27b is colored yellow which represents a predicate, that is, a (transitive) verb and the third color display portion 27c is colored blue which represents an object, and a fourth color display portion 27d is colored sky-blue which represents an objective complement.

Correspondingly, post-its 30 having the size, the shape, and the color matching with the language type input fields 26a, 26b, 26c, and 26d of the second surface 23b are provided. The language type input fields 32a, 32b, 32c, and 32d provided on the surface of the post-its 30 are provided by printing a subject, a predicate, an object, and an objective complement in advance, respectively.

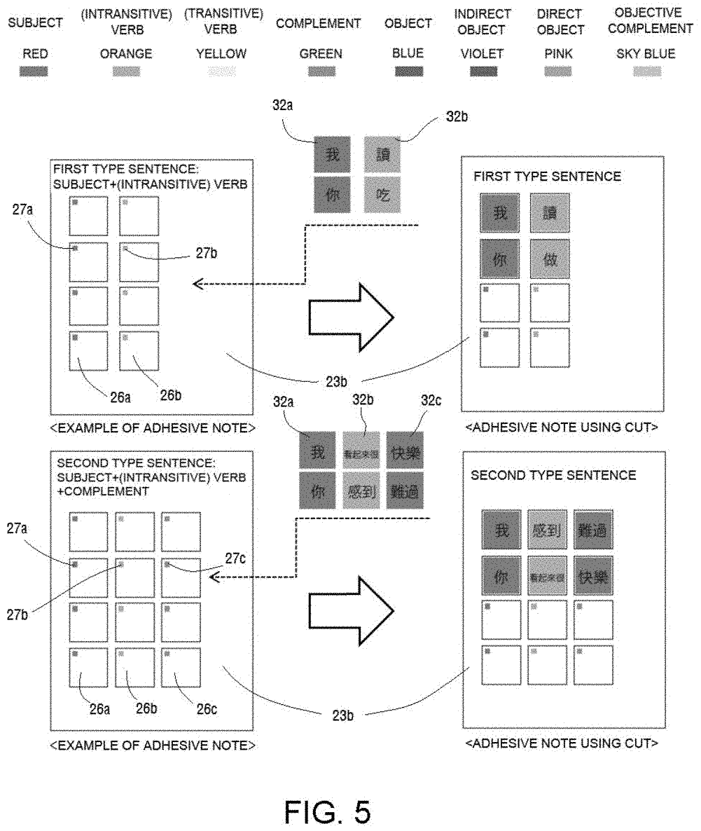

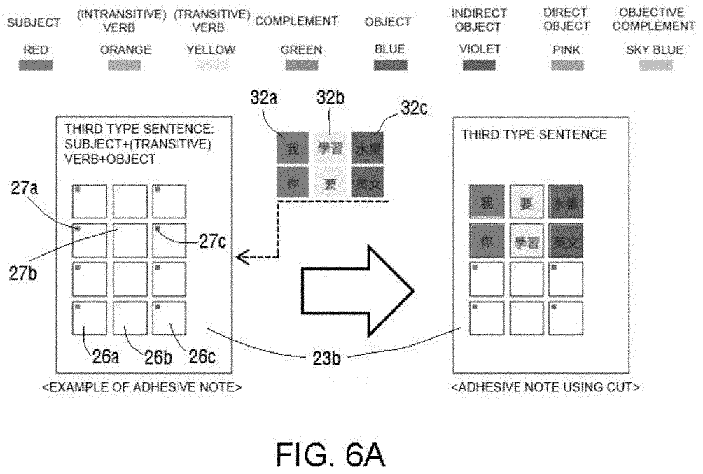

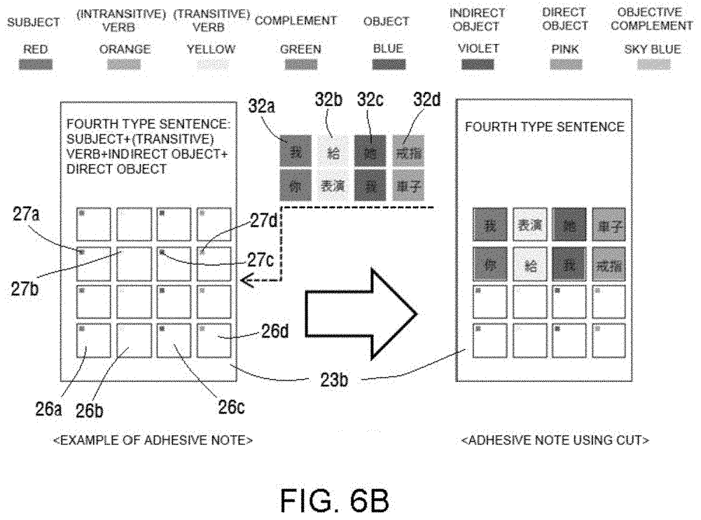

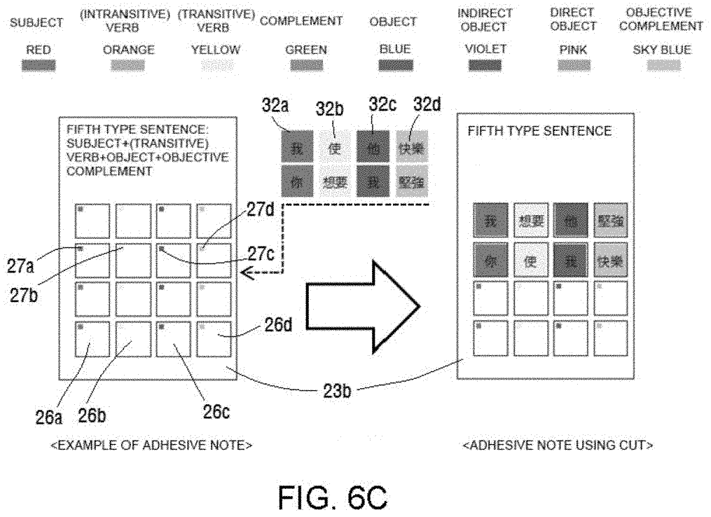

FIGS. 5 and 6A-6C illustrate an example of learning a first type sentence to a fifth type sentence of Chinese using the adhesive note set 10.

Referring to FIGS. 5 and 6A-6C, in the second surface 23b and the post-its 30 of the adhesive note set 10, a color representing a subject in Chinese is designated as red, a color representing a (intransitive) verb in Chinese is designated as orange, and a color representing a (transitive) verb in Chinese is designated as yellow. The color representing a complement in Chinese is designated as green, the color representing an object in Chinese is designated as blue, the color representing an indirect object in Chinese is designated as violet, the color representing a direct object is designated as pink, and the color representing an objective complement in Chinese is sky-blue, respectively.

Since a Chinese learning method illustrated in FIGS. 5 and 6A-6C is the same as the English learning method described above with reference to FIGS. 3 and 4A-4C, a detailed description thereof will be omitted.

The description described above is just an example of an explanation of the technical spirit of the present invention, and it will be apparent to those skilled in the art that various modifications and variations can be made without departing from the essential characteristics of the invention. Therefore, the embodiments described in the present specification are intended to illustrate rather than limit the technical spirit of the present invention, and the scope of the present invention is not limited by these embodiments. The protection scope of the present invention should be construed according to the following claims, and all technical spirits which are equivalent or are in the equivalent scope thereto should be interpreted as being included in the protection scope of the present invention.

### EXPLANATION OF SYMBOLS

10: adhesive note set 20: adhesive note
23: inlay 23a: first surface
23b: second surface 26a-26d, 32a-32d: language type input field
27a-27d: color display portion 30: post-it
100: manufacturing device 200: loading box
300: automatic paper feeder 410, 420: conveyor
500: transfer roll 600: impressing roll
700: coating roll 710: heater
800: storage box 900: release agent supplying tank
910: pump 920: jet nozzle
950: hot-melt adhesive melt tank 960: heating line
M: hot-melt adhesives P1: initial paper
P2: paper coated with release agent P2′: inverted paper
P3: adhesive note inlay

What is claimed is:

1. An adhesive note set 10 for foreign language learning comprising:
an adhesive note 20 which includes a note cover composed of a front cover 21 and a back cover 22, and a plurality of inlays 23, one edge of which is integrally joined to an inside surface of the note cover by adhesives or binding means, wherein a release agent S is coated on a first surface 23a of the inlay 23 with a predetermined thickness, hot-melt adhesives M are coated on a second surface 23b of the inlay 23 with a predetermined thickness, and types of a subject part and a predicate part of the foreign language are printed on the second surface 23b in a state of being divided by color in advance; and
post-its 30 which can be detachably attached to the second surface 23b, and in which words representing the subject part and the predicate part, respectively, are printed on the surface in a state of being divided by color in advance, corresponding to the types of the subject part and the predicate part of the foreign language printed on the second surface 23b.

2. The adhesive note set for foreign language learning according to claim 1,
wherein the release agent S is coated on the first surface 23a with a thickness of 10-12 μm, and the hot-melt adhesives M are coated on the second surface 23b with a thickness of 10-12 μm.

3. The adhesive note set for foreign language learning according to claim 1,
wherein the release agent S is composed of a silicon mixture solution and is prepared by not more than 30 parts by weight of aminopropylaminoethylpolysiloxane and not more than 65 parts by weight of water, with respect to 100 parts by weight of the silicone mixture solution.

4. The adhesive note set for foreign language learning according to claim 1,
wherein the hot-melt adhesives M are composed of an acrylic adhesive coating solution and are prepared by 48 to 52 parts by weight of water, 48 to 52 parts by weight of acrylic polymer, and 0.5 to 1.5 parts by weight of a surfactant, with respect to 100 parts by weight of the acrylic adhesive coating solution.

5. The adhesive note set for foreign language learning according to claim 1,
wherein in a case where the types of the subject part and the predicate part of the corresponding foreign language printed on the second surface 23b are the first types, two language type input fields 26a and 26b each representing a subject and a verb are printed in color in advance, and
wherein a first input field 26a of the two language type input fields 26a and 26b is printed in red corresponding to a subject and a second input field 26b of the two language type input fields 26a and 26b is printed in orange corresponding to a verb, and correspondingly, the post-its 30 having a size, a shape, and a color matching with the language type input fields 26a and 26b are provided, and words corresponding to a subject and a verb are printed in advance in language type input fields 32a and 32b provided on the surface of the post-its 30 and are provided.

6. The adhesive note set for foreign language learning according to claim 1,
wherein in a case where the types of the subject part and the predicate part of the corresponding foreign language printed on the second surface 23b are the second types, three language type input fields 26a, 26b, and 26c each representing a subject, a (intransitive) verb, and a complement are printed in color in advance, and
wherein a first input field 26a of the three language type input fields 26a, 26b, and 26c is printed in red corresponding to a subject, a second input field 26b of the three language type input fields 26a, 26b, and 26c is printed in orange corresponding to a (intransitive) verb, and a third input field 26c of the three language type input fields 26a, 26b, and 26c is printed in green corresponding to a complement, and accordingly, the post-its 30 having a size, a shape, and a color matching with the language type input fields 26a, 26b, and 26c are provided, and words corresponding to a subject and a (intransitive) verb, and a complement are printed in advance in language type input fields 32a, 32b, and 32c provided on the surface of the post-its 30 and are provided.

7. The adhesive note set for foreign language learning according to claim 1,
wherein in a case where the types of the subject part and the predicate part of the corresponding foreign language printed on the second surface 23b are the third types, three language type input fields 26a, 26b, and 26c each representing a subject, a (transitive) verb, and an object are printed in color in advance, and
wherein a first input field 26a of the three language type input fields 26a, 26b, and 26c is printed in red corresponding to a subject, a second input field 26b of the three language type input fields 26a, 26b, and 26c is printed in yellow corresponding to a (transitive) verb, and a third input field 26c of the three language type input fields 26a, 26b, and 26c is printed in blue corresponding to an object, and accordingly, the post-its 30 having a size, a shape, and a color matching with the language type input fields 26a, 26b, and 26c are provided, and words corresponding to a subject, a (transitive) verb, and an object are printed in advance in language type input fields 32a, 32b, and 32c provided on the surface of the post-its 30 and are provided.

8. The adhesive note set for foreign language learning according to claim 1,
wherein in a case where the types of the subject part and the predicate part of the corresponding foreign language printed on the second surface 23b are the fourth types, four language type input fields 26a, 26b, 26c, and 26d each representing a subject, a (transitive) verb, an indirect object, and a direct object are printed in color in advance, and
wherein a first input field 26a of the four language type input fields 26a, 26b, 26c, and 26d is printed in red corresponding to a subject, a second input field 26b of the four language type input fields 26a, 26b, 26c, and 26d is printed in yellow corresponding to a (transitive) verb, a third input field 26c of the four language type input fields 26a, 26b, 26c, and 26d is printed in violet corresponding to an indirect object, and a fourth input field 26d of the four language type input fields 26a, 26b, 26c, and 26d is printed in pink corresponding to a direct object, and accordingly, the post-its 30 having a size, a shape, and a color matching with the language type input fields 26a, 26b, 26c, and 26d are provided, and words corresponding to a subject, a (transitive) verb, an indirect object, and a direct object are printed in advance in language type input fields 32a, 32b, 32c, and 32d provided on the surface of the post-its 30 and are provided.

9. The adhesive note set for foreign language learning according to claim 1,
wherein in a case where the types of the subject part and the predicate part of the corresponding foreign language printed on the second surface 23b are the fifth types, four language type input fields 26a, 26b, 26c, and 26d each representing a subject, a (transitive) verb, an object, and an objective complement are printed in color in advance, and
wherein a first input field 26a of the four language type input fields 26a, 26b, 26c, and 26d is printed in red corresponding to a subject, a second input field 26b of the four language type input fields 26a, 26b, 26c, and 26d is printed in yellow corresponding to a (transitive) verb, a third input field 26c of the four language type input fields 26a, 26b, 26c, and 26d is printed in blue corresponding to an object, and a fourth input field 26d of the four language type input fields 26a, 26b, 26c, and 26d is printed in sky-blue corresponding to an objective complement, and accordingly, the post-its 30 having a size, a shape, and a color matching with the language type input fields 26a, 26b, 26c, and 26d are provided, and words corresponding to a subject, and a (transitive) verb, an object, and an objective complement are printed in advance in language type input fields 32a, 32b, 32c, and 32d provided on the surface of the post-its 30 and are provided.

10. A manufacturing device 100 of an adhesive note set for foreign language learning, comprising:
an automatic paper feeder 300 and a paper loading conveyor 410 for supplying a large amount of initial paper P1;
a transfer roll 500 and an impressing roll 600 which are vertically disposed on an outlet side of the paper loading conveyor 410 in a state of forming a pair, rotate in directions opposite to each other, and are spaced apart from each other so as to allow the initial paper P1 to pass therethrough;
a coating roll 700 which is disposed on one side of the transfer roll 500 in the radial direction, has a heater 710 disposed therein, and rotates in a direction opposite to a rotating direction of the transfer roll 500;
a transfer conveyor 420 which is disposed downstream of the coating roll 700 at the outlet sides of the transfer roll 500 and the impressing roll 600;
a release agent supplying tank 900 which is disposed at an adjacent position of one side of the coating roll 700 in the radial direction and holds and supplies a release agent to be applied to one surface of the initial paper P1 with a predetermined thickness; and
a hot-melt adhesive melt tank 950 which is disposed in parallel with the release agent supplying tank 900 at an adjacent position of one side of the coating roll 700 in the radial direction and holds and supplies hot-melt adhesives to be applied to the other surface of the paper P2 coated with the release agent with a predetermined thickness, wherein a heating line 960 is built in and disposed on a side wall and a bottom of the hot-melt adhesive melt tank 950.

11. The manufacturing device of an adhesive note set for foreign language learning according to claim 10,
wherein a pump 910 and a jet nozzle 920 are installed on one side of the release agent supplying tank 900,
wherein the jet nozzle 920 is disposed such that an outlet side thereof is close to the outer surface of the coating roll 700 in the radial direction, and
wherein the silicon mixture solution S is pumped by the pump 910 from the release agent supplying tank 900 and is provided onto the outer surface of the coating roll 700 in the radial direction via the jet nozzle 920.
